(19) United States
(12) Patent Application Publication
(10) Pub. No.: US 2018/0361615 A1
(43) Pub. Date: Dec. 20, 2018

(54) Compound Lumber Product

(71) Applicant: Kunjie Wang, Fuzhou (CN)

(72) Inventor: Kunjie Wang, Fuzhou (CN)

(21) Appl. No.: 16/012,110

(22) Filed: Jun. 19, 2018

(30) Foreign Application Priority Data
Jun. 19, 2017 (CA) 2971049

(51) Int. Cl. B27M 3/00; B27D 1/08; B27F 1/16; B27M 3/18

(52) U.S. Cl. CPC B27M 3/0013; B27D 1/08; B32B 1/04; B27M 3/18; B27F 1/16

(57) ABSTRACT

The present invention discloses a compound lumber product, relating to the technical field of wooden materials for making furniture, and particularly to a compound lumber product that may be used for making furniture. The compound lumber product includes a core lumber and side-members surrounding the core lumber. The core lumber may be one piece or formed from several core members. The side-members may be single-piece or formed by joining together several high-grade wood boards or strips. Side-members are arranged side by side around the outer surface of the core lumber, wrapping around the core lumber with tail edge of a preceding side-member secured or connected to the inner side-face of the subsequent adjoining side-member at its head edge in a head-to-tail manner, to form the enclosure structure.

### TECHNICAL FIELD

The present invention relates to the technical field of preparing wooden materials for making furniture, and particularly to a compound lumber product that may be used for making furniture.

### BACKGROUND ART

At present, the majority of furniture manufacturers make high-quality furniture components such as stair handrails from high-grade one-piece solid wood. Due to the increasing market demand for wood products and the controlled and regulated use of forest resources, such one-piece high-grade solid wood are of high demand and are generally very costly. This may adversely affect price and sales volume of such wood products and make their marketing promotion more difficult. To address this difficulty, it is known to glue several solid wood boards together to form a multi-layer compound wood materials from which wood furniture products are made. However, these compound wood materials also require a large amount of high-grade wood, resulting in high cost. Moreover, it is prone to forming cracks, deformation or other defects in the manufacturing process at joints or bonding surfaces.

The forgoing creates challenges and constraints for supplying furniture products made from woods. It is an object of the present invention to mitigate or obviate at least one of the above mentioned disadvantages.

### SUMMARY OF THE INVENTION

The present invention provides a compound lumber product. The compound lumber product includes a core lumber and side-members surrounding the core lumber. The core lumber may be formed from several core members. The side-members may be single-piece or formed by joining together several wood boards or strips, which may be of higher grade than that of the core lumber. Side-members are arranged side by side around the outer surface of the core lumber, wrapping around the core lumber with tail edge of a preceding side-member secured or connected to the inner side-face of the subsequent adjoining side-member at its head edge in a head-to-tail manner, to form the enclosure structure.

In one aspect of the invention, there is provided a compound lumber product that comprises a core lumber having a multi-layer structure formed from layers of core members and an enclosure structure surrounding and secured to the core lumber. The core lumber has a central axis, which defines a turning direction around the central axis. The enclosure structure comprises a plurality of side-members that are connected head-to-tail together along the turning direction to form the enclosure structure, and each of the plurality of the side-members has its tail edge secured to and covered by an inner surface of its adjoining and subsequent side-member. At least one of the side-members has a grade higher than that of the core members.

The layers of core members may be stacked along the thickness direction of the core members and connected together to form the multi-layer structure. Each layer of the core members may be either formed from a plurality of core pieces joined together, each of which may be finger-jointed together by saw-toothed sockets, or may be a single core piece. As a feature, finger-joints on neighboring core members are interlaced with each other.

The plurality of core pieces may be made of same material. One or more layers of veneers may be adhered onto an outer surface of enclosure structure, and may cover a portion of side-members of lower grade.

The side-members also may be formed by joining a plurality of side pieces, e.g., finger-jointed through embeddable sockets which comprise saw-toothed sockets. As one feature, at least one side piece has a grade higher than that of other of the plurality of side pieces.

As a feature, the longitudinal sides of the next neighbor side-members are joined in the same manner in that a trailing end face at a longitudinal side of the each one side-member is successively connected to an inner side-face of the subsequent side-member.

The core lumber may have a polygonal cross-section, such as triangular, rectangular, pentagon and hexagonal, and each of the plurality of the side-members is secured to each one of the sides of the polygon.

The side-members may have the same thickness. The side-members may have the same grade that is higher than that of the core lumber.

In another aspect of the invention, there is provided a wooden stair handrail manufactured from such a compound lumber product.

In yet another aspect of the invention, there is provided a furniture product having a support member manufactured from such a compound lumber product.

In other aspects the invention provides various combinations and subsets of the aspects described above.

### THE DESCRIPTION OF DRAWINGS

For the purposes of description, but not of limitation, the foregoing and other aspects of the invention are explained in greater detail with reference to the accompanying drawings, in which:

FIG. 1 is a schematic diagram of one embodiment of a compound lumber product according to the present invention;

FIG. 2 is a schematic diagram of a core lumber used in one embodiment of the compound lumber product according to the present invention;

FIG. 3 is a schematic diagram of side-members in one embodiment;

FIG. 4 is a cross-sectional view of one embodiment of the compound lumber product;

FIG. 4A is a cross-sectional view showing disassembled adjacent side-members;

FIG. 4B illustrates in further detail connections between neighboring side-members of the embodiment shown in FIG. 4;

FIG. 5 is an exploded view of an example of a compound lumber product;

FIG. 6 is a cross-sectional view of another example of the compound lumber product;

FIG. 7 is a schematic diagram of still another embodiment of the compound lumber product according to the present invention;

FIG. 8 is a cross-sectional view of still another embodiment of the compound lumber product according to the present invention; and

FIG. 9 is a schematic diagram of a stair handrail manufactured in still another embodiment of the compound lumber product according to the present invention.

### DETAILED DESCRIPTION OF THE PREFERRED EMBODIMENT

The description which follows and the embodiments described therein are provided by way of illustration of an example, or examples, of particular embodiments of the principles of the present invention. These examples are provided for the purposes of explanation and illustration, and not limitation, of those principles and of the invention. In the description which follows, like parts are marked throughout the specification and the drawings with the same respective reference numerals.

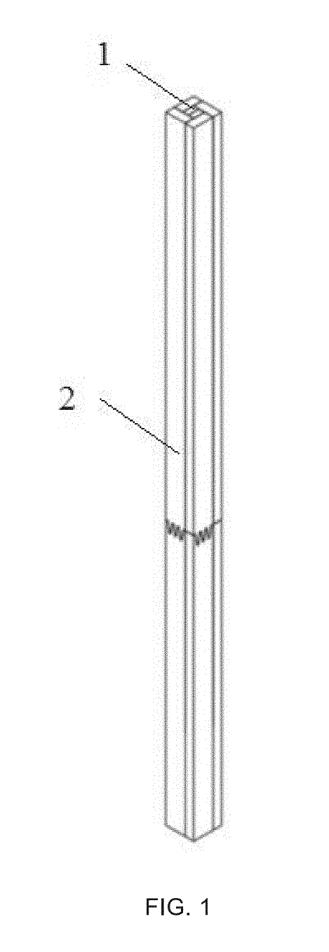

As shown in FIG. 1 through FIG. 5, a compound lumber product includes a core lumber 1 and side-members 2. The core lumber 1 may be of a one-piece structure (i.e., a mono-block structure) or a multi-layer structure formed from several core members (such as core boards). A number of side-members 2 (such as side boards) are arranged around outside surfaces of the core lumber 1 to form an enclosure structure, which may be one layer or multi-layers. Adjacent side-members 2 are fixedly connected with each other along their respective longitudinal sides. Each side-member 2 is fixedly connected to the core lumber 1, too. Here, “transverse direction” refers to a cross-sectional direction of both the core lumber 1 and the side-members 2, and the “longitudinal direction” is a direction that intersects the transverse direction and is along a length of the core lumber 1 and the side-members 2.

A side-member 2 is fixedly connected to an adjoining side-member along their respective longitudinal sides, and secured to core member 1. Side-members may be secured or connected to each other in various ways as appropriate. For example, the adjacent side-members 2 may be glued by an adhesive; or, tongues and grooves may be formed on adjoining longitudinal sides of the adjacent side-members 2, respectively, so that the longitudinal sides are connected via the tongues and the grooves. The number, thickness and width of the plurality of side-members 2 may be selected as required by the manufactured furniture products, which may include table legs, bedsteads or the like.

Each side-member 2 is secured to core lumber 1 and may be secured to core lumber 1 in various ways. For example, the side-members 2 may be glued to the core lumber 1 by an adhesive; or, tongues and grooves may be formed on the side-members 2 and the core lumber 1, respectively, so that the side-members 2 may be secured to the core lumber 1 via the tongues and the grooves. A side-member 2 may be secured to the core lumber 1 directly, or via a suitable intermediary, such as a connecting, additional layer of wood, or a connecting, non-wood piece.

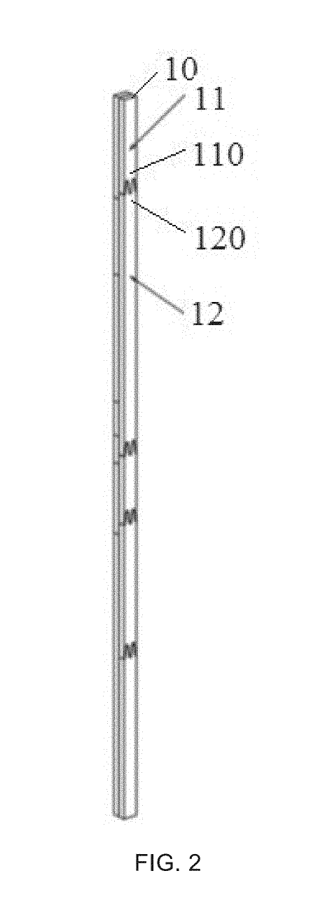

As required or according to design requirements, the core lumber 1 may be of a one-piece structure, or may be formed from a plurality of core members. Each core member 10 may be in the nature of a board such as shown in FIG. 2. As can be seen in FIG. 2, several core members 10 may be joined or bonded together to form a multi-layer structure. Each layer may contain one or more core members. Each core member may itself be formed from a plurality of core pieces 11, 12. The core pieces may also be arranged and connected in various ways. For example, the core pieces may be connected by tongue-and-groove pairing, finger-jointing or in any other suitable manner.

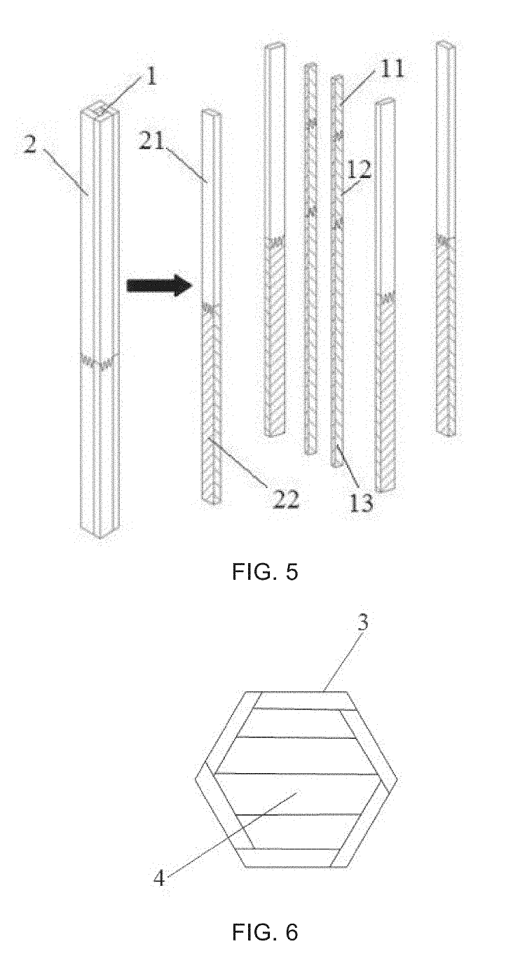

In one embodiment, as shown in FIG. 2 and FIG. 5, a core member 10 is formed by joining a plurality of core pieces 11, 12, 13. To join two neighboring core pieces, saw-toothed sockets, for example, may be formed on the bottom 110 of the core piece 11 and the top 120 of the core piece 12. The core piece 11 and the core piece 12 are finger-jointed through the sockets. An adhesive may also be applied in the sockets to enhance the joint.

Referring to FIG. 2, butt-joint teeth on the bottom 110 of the core piece 11 correspond to butt-joint teeth on the top 120 of the core piece 12. For example, the butt-joint teeth may be equal in length and width and distributed uniformly, so that the saw-toothed end faces of the two butt-jointed core pieces 11 and 12 may be tightly and more easily butt-jointed. The core pieces 11,12 may be made of the same material or different materials.

As an example, core pieces 11 and 12 are finger-jointed to form a core member 10. Several core members 10 so formed (two are shown in FIG. 2) are glued to form a core lumber 1 which has a multi-layer structure. The plurality of core members 10 may be arranged in various ways. For example, the plurality of core members 10 may be stacked along the thickness direction thereof and glued to form the multi-layer structure. Location of finger-joints on neighboring core members 10 in the stack are spaced apart along the longitudinal direction. This interlaced arrangement of finger-joints of adjacent core members tends to enhance mechanical strength and manufacturability of core lumber 1.

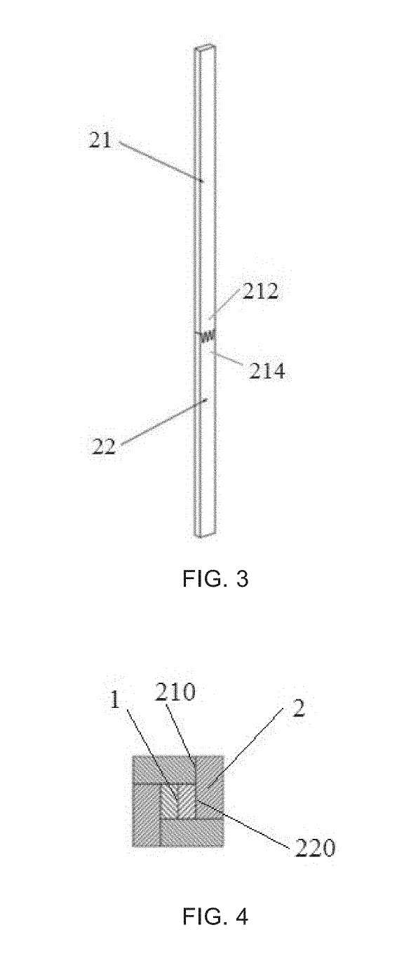

The side-members 2 may be formed from several side pieces 21, 22 (such as side strips) by joining them together. They may be joined in any suitable manner. For example, FIG. 3 shows a side-member 2 formed from a first side piece 21 and a second side piece 22. The lower end 212 of the first side piece 21 and the upper end 214 of the second side piece 22 are finger-jointed through saw-toothed sockets.

The first side piece 21 may be one-piece wood, and the second side piece 22 may be formed from several boards or strips. The selection of size, quality, structure etc. of the first side piece 21 and the second side piece 22 is generally determined as required by the manufactured furniture products. For example, the first side piece 21 may be a high-grade one-piece wood strip, and the second side piece 22 may be formed from a plurality of low-grade wood strips.

In one embodiment, the side-members 2 may have a wood grade or quality different than that of the core lumber 1, and different raw materials may be used as suitable for the furniture products to be manufactured. As referenced herein, wood grade generally refers to that established by national or industry standards or established by design requirements, and generally may be set according to wood defects, source origin, wood type, mechanical performance indicators or the like. Generally, a higher grade indicates that the wood has better mechanical performance, less appearance defects, higher price, among others.

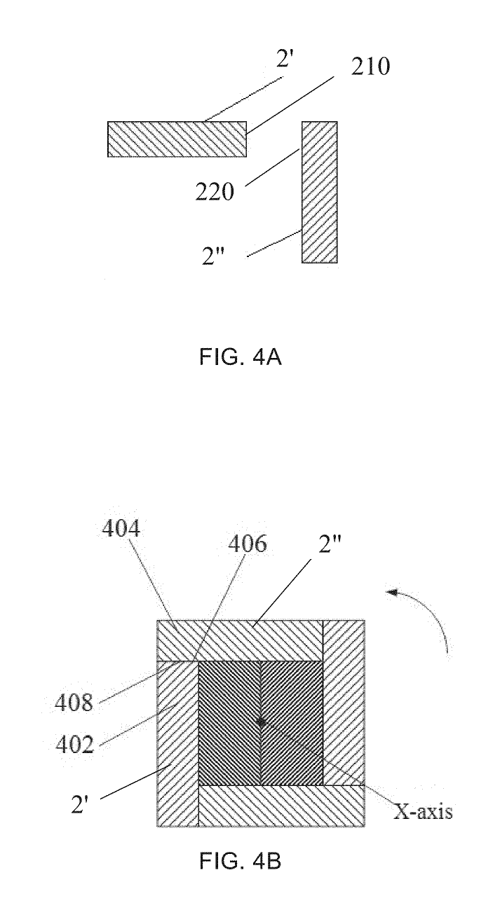

As shown in FIG. 4, four pieces of side-members 2 and the core lumber 1 are bonded together by glue. The side-members 2 are of higher grade and enclose the core lumber 1 of lower grade to form the compound lumber product. As the core lumber is of lower grade, usage of high-grade wood may be reduced.

In FIG. 5, the shaded portion indicates wood of lower grade, and the remaining non-shaded portion indicates wood of higher grade. In other words, the first side piece 21 is made of wood of higher grade; and the second side piece 22 and the core pieces 11, 12 and 13 are made of wood of lower grade. Generally, woods such as oak, maple etc. are considered to be of higher grade, and artificial wood, wood with more defects such as rubber wood or pine wood, are generally considered to be of lower grade.

In one example, the grade of the first side piece 21 is higher than that of the second side piece 22, and is also higher than that of the core pieces 11, 12 and 13. The grade of the core pieces 11, 12 and 13 may be the same as that of the second side piece 22. Furthermore, same kind of wood may be used for both the core pieces 11, 12 and 13, for example, and for the second side piece 22.

The cross-section of the compound lumber product may be different as required and is not necessarily rectangular. For example, the compound lumber product may have a polygonal cross-section, such as a triangular, rectangular, pentagon or hexagonal cross-section, and the length of each side of the polygon may be different if necessary. FIG. 4 shows an example in which the core lumber 1 is of a two-layer structure, and the core lumber 1 has a rectangular cross-section. To each longitudinal side-face of the core lumber 1 is secured one side-member 2, and four side-members 2 surround the four sides of the core lumber 1 to form a one-layer enclosure structure. FIG. 6 shows a core lumber 4 that has a four-layer structure, and has a hexagonal cross-section. One side-member 3 is secured to each longitudinal side-face of the core lumber 4, and six side-members 3 surround the six sides of the core lumber 4 to form a one-layer enclosure structure.

The side-members may be arranged around the core lumber in various ways. As an example shown in FIGS. 4, 4A and 4B, the core lumber 1 has a rectangular cross-section. Four side-members 2 sequentially wrap around the outer faces of the core lumber, in a counter-clockwise direction and head-to-tail manner, namely with trailing longitudinal side of each side-member 2 successively connected to a longitudinal inner side-face of the side-member 2 near its head or leading edge. For example, the trailing end 210 of longitudinal side of one side-member 2′ is connected to a longitudinal inner side-face 220 of the subsequent one 2″ of the side-members, so that the four pieces of side-members 2 wrap around the core lumber 1, “turning” about its longitudinal axis X in the same direction. When the compound lumber product is turned by a rotary cutting apparatus, for example, a lathe, and when the cutting tool cuts the enclosure formed by the side-members 2 along the same turning direction, the possibility of cracking between side-members 2 may be minimized and the wear to the lathe tool may be reduced too, thus promoting good manufacturability.

Referring to FIG. 4B, the arrangement of side-members 2 wrapping around the core lumber 1 is explained in further detail. The side-members “turn” in a counterclockwise direction around the longitudinal axis X of the core lumber 1 and successively connect to the next side-member head-to-tail in the same direction. In the direction of turning, the tail end 402 of the preceding side-member 2′ is secured or connected to the inner side-face 406 of the subsequent side-member 2″ at its head end 404 to form the head-to-tail connection, so that the core lumber 1 is surrounded by an enclosure structure formed by the four pieces of side-members. The longitudinal inner side-face 406 at the head end 404 of the subsequent side-member 2 covers and is fixedly connected to a longitudinal end face 408 of the tail end 402 of the preceding side-member 2′. The longitudinal inner side-face 406 and the longitudinal end face 408 may be joined together by glue.

The polygon of core lumber cross-section may have more or less sides. When a compound lumber product has a different cross-section shape, the side-members may be similarly arranged head-to-tail and turning in the same direction about the longitudinal axis to enclose and surround the core lumber. More or less side-members may be “turned” around the longitudinal axis of the core lumber in a fixed direction (e.g., clockwise or counterclockwise) to surround the core lumber. For example, FIG. 6 shows an example of a core lumber of hexagonal cross-section where six side-members are “turned” in a clockwise direction to wrap around or surround the core lumber.

One or more layers of veneers may be applied to (e.g., adhered onto) an outer surface of the enclosure structure formed from the side-members 2. The veneers are generally thin and are generally applied as needed.

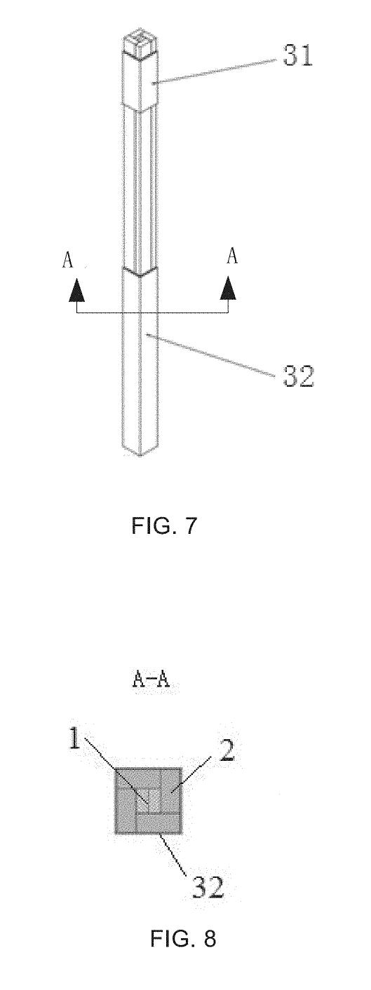

FIGS. 7 and 8 show another example of four pieces of side-members 2 forming a one-layer enclosure structure, with one layer of veneers secured to the outer surface of the enclosure structure. The veneers may extend the entire length of the compound lumber product, or may be in separate pieces and separately applied to the upper portion and lower portion of the compound lumber product, respectively. Consider one example of a side-member having a first side piece made of high-grade wood and a second side piece made of low-grade wood. Two veneers 31, 32 are applied to the side-member which consists of the high-grade, first side piece, and low-grade, second side-piece. The grade of the veneers 31 and 32 may be higher than that of the low grade, second side piece, and decorative texture may be provided on the veneers 31 and 32.

The veneers 31 and 32 may be made from oak, maple or other wood of similar quality. Veneers 31 and 32 of higher grade may be glued to cover lower grade wood, without significantly changing the outer dimensions of the finished product. Accordingly, the usage of high-grade wood may be reduced even further.

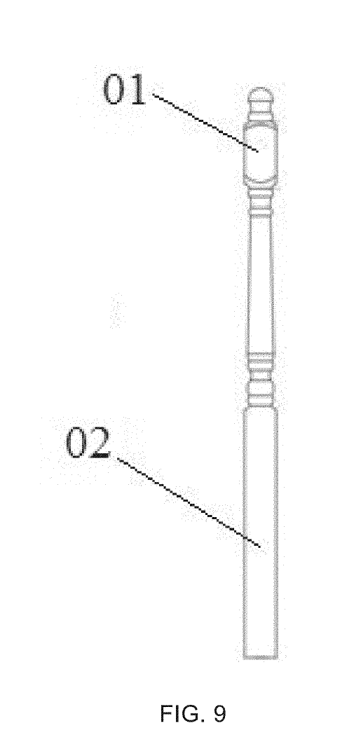

Veneers 31 and 32 may remain after the compound lumber is machined. As shown in FIG. 9, the veneers 31 and 32 remain on the outer surface of the head 01 and pillar 02 of the machined stair handrail. This may improve appearance quality of the wooden handrail. The natural texture and wood pattern may be preserved, and the visual difference between regions of the finished product may be minimized.

The compound lumber product described in various examples herein includes a core lumber and side-members surrounding the core lumber. The core lumber may be formed from several layers of core members, each of which may be further formed by joining together several core pieces, such as low-grade boards. The side-members may be single-piece or formed by joining together several boards or strips, such as high-grade wood boards or strips. Optionally side-members may be formed from low-grade wood boards. This tends to reduce the amount of usage of high-grade wood. Moreover, this also promotes improved mechanical performance and manufacturability of the resulting lumber product. Consequently, the manufactured furniture products tend to exhibit exquisite texture of high-grade wood, while at the same time reduce the use of high-grade wood.

As will be understood by those skilled in the art, unless otherwise stated, if a numerical range is disclosed in any technical solution in the present specification, the disclosed numerical range is a preferred numerical range, and the preferred numerical range merely shows certain representative numerical values among many feasible numerical values. It is not possible to exhaustively list all possible numerical values. The disclosed numerical values are to illustrate the technical solutions, and shall not constitute any limitations to the intended scope of the solutions described herein.

Further, when parts or structural members are disclosed as fixedly connected to each other, unless otherwise stated, the fixed connection may be interpreted as being connected fixedly in a detachable manner (for example, connected by bolts or screws), or may be interpreted as being connected fixedly in a non-detachable manner (for example, by gluing). Of course, if appropriate, instead of the fixed connection to each other, a one-piece structure may be used.

Various embodiments of the invention have now been described in detail. Those skilled in the art will appreciate that numerous modifications, adaptations and variations may be made to the embodiments without departing from the scope of the invention, which is defined by the appended claims. The scope of the claims should be given the broadest interpretation consistent with the description as a whole and not to be limited to these embodiments set forth in the examples or detailed description thereof.

What is claimed is:

1. A compound lumber product, comprising:
a core lumber having a multi-layer structure formed from layers of core members, said core lumber having a central axis, the central axis defining a turning direction around the central axis,
an enclosure structure surrounding and secured to the core lumber, the enclosure structure comprising a plurality of side-members, the plurality of side-members being connected head-to-tail together along the turning direction to form the enclosure structure; and
each of the plurality of the side-members having its tail edge secured to and covered by an inner surface of its adjoining and subsequent side-member,
wherein at least one of the plurality of side-members has a grade higher than that of the core members.

2. The compound lumber product of claim 1, wherein the layers of core members are stacked along the thickness direction of the core members and connected together to form the multi-layer structure.

3. The compound lumber product of claim 1, wherein each layer of the core members is either formed from a plurality of core pieces joined together or a single core piece.

4. The compound lumber product of claim 3, wherein the plurality of core pieces are finger-jointed together by saw-toothed sockets formed at corresponding ends of adjoining core pieces.

5. The compound lumber product of claim 4, wherein finger-joints on neighboring core members are interlaced with each other.

6. The compound lumber product of claim 3, wherein the plurality of core pieces are made of same material.

7. The compound lumber product of claim 1, wherein one or more layers of veneers are adhered onto an outer surface of enclosure structure.

8. The compound lumber product of claim 1, wherein the side-members are formed by joining a plurality of side pieces.

9. The compound lumber product of claim 8, wherein adjoining side pieces are finger-jointed through embeddable sockets which comprise saw-toothed sockets.

10. The compound lumber product of claim 8, wherein at least one side piece has a grade higher than that of other of the plurality of side pieces.

11. The compound lumber product of claim 8, wherein at least one side piece is formed by joining a plurality of strips.

12. The compound lumber product of claim 8, wherein one or more layers of veneers are adhered onto an outer surface of enclosure structure and the veneers have a grade higher than at least one of the plurality of side pieces.

13. The compound lumber product of claim 1, wherein the longitudinal sides of the next neighbor side-members are joined in the same manner in that a trailing end face at a longitudinal side of the each one side-member is successively connected to an inner side-face of the subsequent side-member.

14. The compound lumber product of claim 1, wherein the core lumber has a polygonal cross-section and each of the plurality of the side-members is secured to each one of the sides of the polygon.

15. The compound lumber product of claim 14, wherein the polygonal cross-section is one of triangular, rectangular, pentagon and hexagonal.

16. The compound lumber product claim 1, wherein the plurality of side-members have the same grade that is higher than that of any one of the core members.

17. A wooden stair handrail manufactured from a compound lumber product, the compound lumber product comprising:
a core lumber having a multi-layer structure formed from layers of core members, said core lumber having a central axis, the central axis defining a turning direction around the central axis,
an enclosure structure surrounding and secured to the core lumber, the enclosure structure comprising a plurality of side-members, the plurality of side-members being connected head-to-tail together along the turning direction to form the enclosure structure; and
each of the plurality of the side-members having its tail edge secured to and covered by an inner surface of its adjoining and subsequent side-member,
wherein at least one of the plurality of side-members has a grade higher than that of the core members.

18. The wooden stair handrail of claim 17, wherein the longitudinal sides of the next neighbor side-members are joined in the same manner in that a trailing end face at a longitudinal side of the each one side-member is successively connected to an inner side-face of the subsequent side-member.

19. A furniture product having a support member manufactured from a compound lumber product, the compound lumber product comprising:
a core lumber having a multi-layer structure formed from layers of core members, said core lumber having a central axis, the central axis defining a turning direction around the central axis,
an enclosure structure surrounding and secured to the core lumber, the enclosure structure comprising a plurality of side-members, the plurality of side-members being connected head-to-tail together along the turning direction to form the enclosure structure; and
each of the plurality of the side-members having its tail edge secured to and covered by an inner surface of its adjoining and subsequent side-member,
wherein at least one of the plurality of side-members has a grade higher than that of the core members.

20. The furniture product of claim 19, wherein the longitudinal sides of the next neighbor side-members are joined in the same manner in that a trailing end face at a longitudinal side of the each one side-member is successively connected to an inner side-face of the subsequent side-member.
